(19) United States
(12) Patent Application Publication
(10) Pub. No.: US 2016/0209720 A1
(43) Pub. Date: Jul. 21, 2016

(54) Ferroelectric Liquid-Crystal Display Cell

(71) Applicant: Igor Nikolaevich Kompanets, Moscow (RU)

(72) Inventor: Igor Nikolaevich Kompanets, Moscow (RU)

(21) Appl. No.: 13/634,152

(22) PCT Filed: Mar. 10, 2011
(86) PCT No.: PCT/RU2011/000146

§ 371 Date: Mar. 15, 2016

(30) Foreign Application Priority Data
Mar. 11, 2010 (RU) 2010108836

(51) Int. Cl. G02F 1/141

(52) U.S. Cl. CPC G02F 1/141

(57) ABSTRACT

The invention relates to the field of optoelectronics and can be used in devices and systems for the visualization, imaging, storage and processing of information, in particular in two-dimensional and three-dimensional displays (including computer and television displays), light modulators (including spatial light modulators), image processing and recognition devices, etc. A ferroelectric liquid crystal display cell is proposed in which the layer thickness and helicoid pitch of the liquid crystal are related to the boundary conditions by a given relationship which provides for given physical and functional properties of the ferroelectric liquid crystal cell, namely: a continuous anhysteretic modulation characteristic; the addressing of the cell by alternating positive and negative pulses of an amplitude of less than ±3 W at a light modulation frequency of several kilohertz; reduced energy consumption; and improved definition by comparison with a nematic crystal display cell,

### PERTINENT ART

This application claims priority to Russian application number 2010108836 filed on Mar. 11, 2010, and International application number PCT/RU2011/00146 filed on Mar. 10, 2011. The invention pertains to the field of optoelectronics and can be used in devices and systems of imaging, displaying, storage and processing of data, possessing high data capacity, particularly in two-dimensional and three-dimensional displays, including computer and television ones, in light modulators, including spatial ones, in devices of image processing and recognition, of data storage and conversion etc.

### PRIOR ART

At the present time liquid crystal (LC) displays and spatial light modulators (SLM) are the most popular type of such devices: about a billion exemplars of LC displays alone are produced in the world every year. They mainly use liquid crystals of the nematic type (NLC). The basis for creation of whole LC industry was the high efficiency of light electrooptic modulation in NLC (at the expense of large value of birefringence change) at low control voltage (units of volts) [1, 2].

For observation of light modulation the liquid-crystal display cell with NLC is placed between crossed polaroids (polarizer and analyser). Modulation characteristic is smooth and generally for different electrooptic effects obeys the law

I=I₀·sin²(Γ/2), (1)

where I₀ and I is light intensity, correspondingly, one incident onto polarizer and one that passed behind the analyser, and Γ=2π·Δn·d/π is a phase delay between ordinary and extraordinary ray that is determined with the value of birefringence change Δn, NLC layer thickness d and length of modulated wave λ. This characteristic provides good dithering (grey scale) together with the colour transfer.

The time of reorientation of NLC molecules in display cell and thus the time of switching on and off of some electrooptic effect used for light modulation are described with the following correlations:

τₒₙ=4πγ₁d²/(Δε·U²−4π³K), (2)

τ_{off}=γ₁d²/π²K, (3)

where γ₁ is the rotational viscosity; K is the elasticity modulus; Δε is the anisotropy of dielectric permittivity, equal to the difference between values of dielectric permittivity measured along the long axis (ε_{∥}) and the short axis (ε_{⊥}) of molecules, correspondingly; d is the thickness of LC layer; U is the amplitude of applied voltage.

The time of electrooptic response to the applied voltage τₒₙ amounts units to tens of milliseconds and doesn't depend on the voltage sign by virtue of quadratic dependence on voltage of all the electrooptic effects in NLC. After switching the applied voltage off, the molecules orientate back to the initial state under the action of force, caused with elastic deformation of molecular structure of NLC layer. Time τ_{off} of switching off (relaxation) is independent on voltage; it is directly proportional to square of LC layer thickness, directly proportional to relation of constitutive parameters γ₁/K and can vary from hundreds to units of milliseconds. In practice, namely this time restricts the response speed of NLC-display cells.

It is known the ferroelectric liquid-crystal display cell [2]—a light-modulating electrooptic display cell filled with liquid crystal of smectic type, namely C*—smectic LC (SLC) possessing ferroelectric properties, and in the cell are observed several electrooptic effects that can be used for light modulation [3,4].

### BRIEF DESCRIPTION OF THE FIGURES

FIG. 1a shows a depiction of an electrooptic cell filled with liquid crystals of smectic type (SLC) with the helix pitch distance much less than the layer thickness.

FIG. 1b shows a depiction of an electrooptic cell filled with liquid crystals of smectic type (SLC) with helix pitch distance much greater than the layer thickness.

FIG. 2a shows a view of a transmissive type SLC display cell.

FIG. 2b shows a view of a reflective type SLC display cell.

FIG. 3 shows the stress distribution diagram (bottom diagram) and electrooptic response of liquid-crystal ferroelectric display cell (top diagram) in bistable mode (thick line) and in multistable mode (thin lines).

FIG. 4 shows a plot of the experimentally observed crossed polaroids light transmission, I, by the ferroelectric display cell with one-side dielectric coating in dependence on control voltage U (meander) at frequency of 1 kHz (b) at increase (*) and decrease (∘) of voltage value.

### DETAILED DESCRIPTION OF PREFERRED MODES OF THE DEVICE

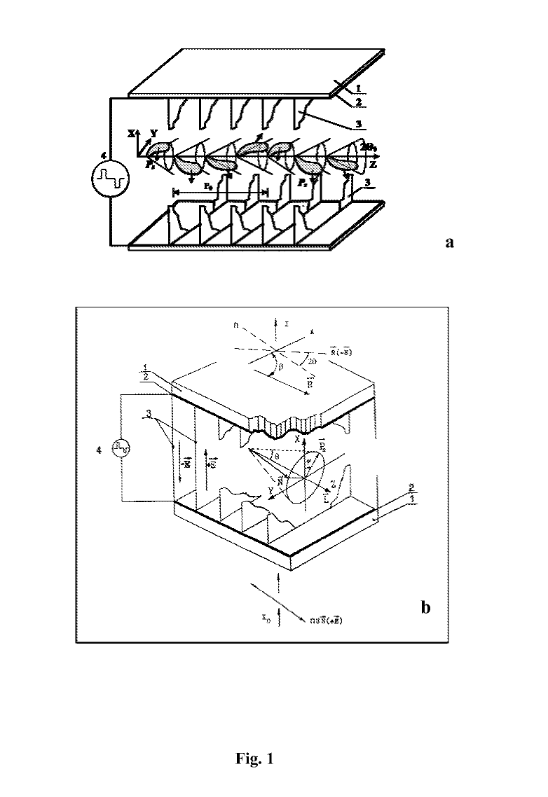

Physical model of electrooptic cell with SLC (SLC-cell) is shown in FIG. 1: a) for SLC with helix pitch distance much less than the layer thickness, and b) for SLC with helix pitch distance much greater than the layer thickness. Here 1 are the transparent dielectric plates (substrates); 2 are transparent current conducting coatings covered with orientant; 3 are planes of liquid crystal smectic layers perpendicular to surface of plates 1; 4 is the electric voltage source; Ē is the electric field vector in the plane of smectic layer; N̅ is a vector showing the direction of molecules long axes orientation in smectic layers (SLC director); P̅ₛ is the vector of spontaneous polarization; p₀ is helicoid pitch; L is a normal to smectic layers; X is the coordinate axis perpendicular to plates 1; Y is the coordinate axis parallel to plates 1; Z is the coordinate axis coinciding the direction of vector L̅; Θ is the slope angle of molecules long axes relatively to vector L̅ (angle between vectors N̅ and L̅ is a polar angle); φ is the angle in XY plane between normal to plates and vector P̅ₛ (azimuth angle); Π and A are the directions of axes of polarizer and analyser transmission; I₀ is the intensity of light incident onto the cell; I is the intensity of light modulated with cell; β is the angle between polarizer and helicoid axis (a), between R and A (b).

In the SLC layer the direction of director—the preferred orientation of molecules long axes —is determined with polar angle Θ—the angle of their declination relatively to normal to smectic layers, and azimuth angle φ in the plane of smectic layer. Due to special stoichiometry of molecules every layer in the absence of external influence possesses spontaneous polarization, and by virtue of that the SLCs have high sensitivity to action of electric field. Polarization vector Pₛ lies in the plane of smectic layer and is directed along polar axis, and polar axes of different smectic layers are rotated relatively each other in such a way that there forms equilibrium helically twisted structure—a helicoid with pitch p₀. However, the macroscopic polarization of cell is absent, because angle φ in smectic layers varies from 0 to π at the distance equal to pitch p₀.

In the electric field E directed along planes of smectic layers the vector of spontaneous polarization tends to orientate along field lines. Due to this the molecules turn along cone generator in such a way that the polar angle θ remains unchanged, and azimuth angle φ changes from 0 to π (FIG. 1). At change of electric field sign the process occurs in reverse direction.

It is known the effect of controlled birefringence used for light modulation in liquid-crystal ferroelectric display cell that is called DHF-effect (from Deformed Helix Ferroelectric). It is related to helicoid deformation and was firstly discovered in USSR [2-4]. The effect is implemented in smectic layer oriented perpendicularly to solid substrates (along the direction of light propagation—FIG. 1a) under the following condition:

p₀<<d, (4a)

i.e. helicoid pitch (usually 0.2÷0.5 μm) must be much less than SLC layer thickness, or, more correctly,

K_{φ}q₀²>>W_{Q}/d, (4b)

where K_{φ}—elasticity modulus specifying SLC deformation over azimuth angle φ; q₀=2π/p₀—helicoid wave vector; W_{Q}—quadratic coefficient of energy of layer cohesion with boundary surface determining boundary conditions for layer. Herewith, for observation of the effect it is important the helix pitch distance also to be much less than light beam aperture (this condition is fulfilled almost always).

This means that the modulation is observed at averaging (over beam cross-section) of phase delays distribution, taking place in spatial modulated birefringent SLC layer (in NLC the same averaging was made over the layer thickness).

Here birefringence change in electric field occurs due to disturbance of helicoid equilibrium spiral. The effect has no threshold and is observed in small fields that are less than critical field of helicoid spiral spin-up. In crossed polaroids is implemented the light intensity modulation with linear grey scale. Times of switching on and off of the electrooptic response of this DHF-modulator are equal and don't depend on electric field, but only depend on constitutive parameters of liquid crystal. In the thin layers of some SLC these times amount 100÷500 microseconds at voltage up to ±1.5 Volt, and in the mode of continuous modulation at control pulses repetition frequency of order of 130 kHz and amplitude of ±40 V they can achieve value of microsecond order [3,4].

It is also known the effect of controlled birefringence called Clark-Lagerwall effect [2-5] that is widely used for light modulation in liquid-crystal ferroelectric display cell. The necessary condition for its observation is the fulfilling of correlation:

p₀>>d, (5a)

i.e. helicoid pitch should be much greater than SLC layer thickness (usually it amounts 1÷2 μm), or, more correct,

K_{φ}q²<<W_{Q}/d. (5b)

Here, as opposed to correlation 4b, q₀ is the deformation wave vector.

Besides, smectic layers must be oriented perpendicularly to solid substrates.

Operating principle of SLC light modulator on the basis of Clark-Lagerwall effect is explained with FIG. 1b. The modulator is controlled with alternating sign electrical pulses from the electric voltage source 4. SLC layer is located between substrates 1 with current conducting coatings 2 deposited on them. Under application of electric field to SLC cell the polarization vector of every smectic layer is settled along the field lines, and molecules long axes are located in the plane of SLC layer at an angle Θ to helicoid axis. At field sign change the polarization vector turns in the opposite direction, and molecules long axes, as cone generators, come to position −Θ in the same plane, i.e. they shift for 2Θ relatively to previous position. Molecules long axes reorientation is followed by birefringence change of SLC layer, and consequently, with phase modulation of passing light that is transformed into amplitude modulation due to polarizers.

FIG. 1b also illustrates the practical implementation of light amplitude modulation in SLC cell. Let the natural unpolarized light with intensity I₀ fall onto it. On passing through the external polarizer the light becomes linearly polarized in the direction of polarizer axis Π. The direction of director N in the cell depends on sign of source 4 voltage, i.e. on the direction of field E. The angle between vectors N(+E) and N(−E) amounts 2Θ. If SLC is located in field +E, and polaroid is oriented in such a way that its axis is parallel to vector N(+E), than the light propagates along principal optic axis of SLC and that is why it doesn't experience the birefringence, and at β=π/2 the cell doesn't transmit the light. If the direction of field will be changed to −E, the light will propagate at an angle 2Θ to main optical axis of SLC and that is why it will experience the birefringence, from whence the light polarization transfers from linear to elliptic polarization. In this case at β=π/2 the cell permits light through.

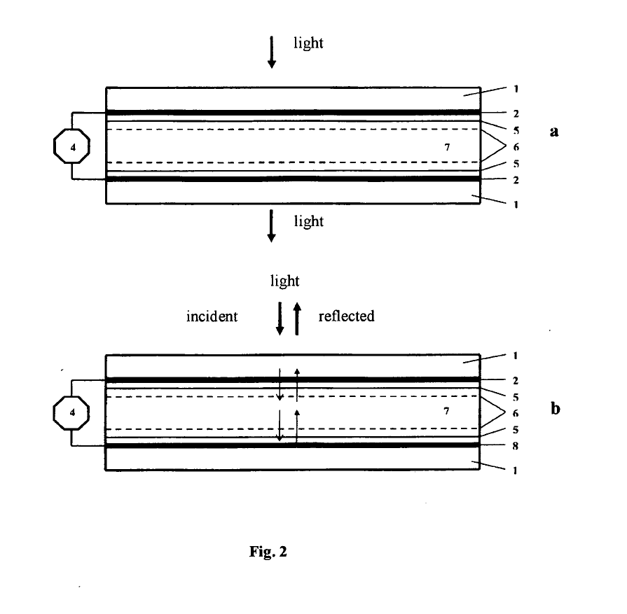

The conceptual design of display cell of <<transmissive>> (a) and <<reflective>> (b) type on the basis of SLC is shown in FIG. 2. Here: 1 are the parallel transparent dielectric plates (substrates); 2 are the transparent current conducting coatings, deposited on sides of substrates facing the SLC (usually with antireflective sublayers); 4 I the source of alternating sign electric voltage; 5 are the transparent anisotropic dielectric coatings (layers of orientant) on one or both current conducting coatings; 6 are the transparent dielectric coatings on one or both substrates; 7 is the liquid-crystal substance (SLC); 8 is the reflective current conducting coating.

SLC layer can change its optical anisotropy depending on amplitude and/or pulse duration of alternating sign electric voltage supplied to current conducting coatings, for example, of indium tin oxide. Initial orientation of molecules long axes of liquid-crystal substance in the absence of external electrical field is defined with anisotropic coating, for example, polyimide film. Dielectric coating, for example, of aluminium oxide, is used for cell protection from electric interlocking and breakdown. The image is observed either at light passing through layer of liquid-crystal substance in one direction, if both dielectric plates—1 and both current conducting coatings—2 are made transparent, or at light double passing, if the second current conducting coating—8 is made not transparent but reflective.

To obtain electrooptic light modulation, crossed polaroids are glued to external sides of glass plates in such a way that polarizer axis coincides the direction of SLC director at φ=0 (equally, at φ=π). The intensity of light that passed behind analyser I is determined in [2] as follows:

I=I₀ Sin² 2[Θ+(N(−E), L)] Sin²(πΔnd/λ), (6)

where: Δn is the value of SLC layer birefringence; d is its thickness; λ is the light wavelength; (N(−E), L) is the angle between vectors N and L. Admissible light transmission of cell T=I/I0=1 is achieved if:

Δnd/λ=1/2, Θ+(N(−E), L)=π/4. (7)

As it is seen, in general case the modulation characteristic is similar to one for nematic LC (see formula (1)), while timing characteristics of light modulation in SLC substantially differ. Indeed, Clark-Lagerwall effect is linear as opposed to quadratic effect in nematics. As far as SLC respond to the sign of applied voltage, times of switching on and off of the electrooptic response here are the same and are defined with the following expression [2]:

τ=2.2·γ_{φ}/(Pₛ·E), (8)

where γ_{φ} is the rotational viscosity corresponding to type of motion of SLC director along generator of cone described above.

Present-day SLCs at alternating sign electric field of several V/μm allow obtaining of time of switching on-off of electrooptic response τ of several microseconds—tens of microseconds, what is two-three times faster, than in NLC. Subsequently, display cell or optical modulator on the basis of SLC provides the frequency of amplitude-phase light modulation of several hundreds of Hertz and even kilohertz.

For restricted value of electric voltage applied to cell, stipulated with implementation of control integrated circuits for achievement of high speed of modulation, it is necessary to increase electric field intensity, i.e. to decrease the thickness of SLC layer. However, in thin SLC layers in the order of 1-1.5 μm the electrooptic switching gains bistable nature due to layer strong interaction with surfaces restricting it. That is why bistable SLC cells of such type are also called superficially-stabilized structures. To obtain stable bistability it is necessary to suppress different deformations of smectic layers, for example deformations like chevrons, what is achieved at the expense of intermolecular interactions in SLC volume [2,4,6,7].

It is known that due to special stoichiometry of SLC the stable bistability can exist even in more thick, with thickness more than 2.5 μm, SLC layers (so called <<volumetric>> bistability [8]), though admissible light modulation frequency in this case is essentially less than at modulation on the basis of Clark-Lagerwall effect.

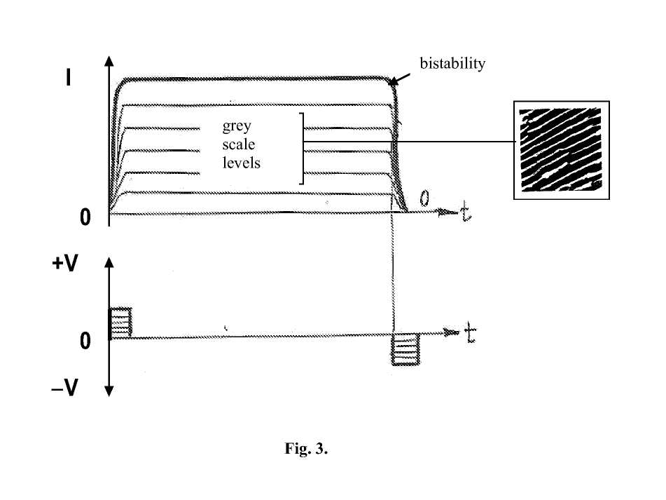

Modulation characteristic of Clark-Lagerwall bistable display cell has only two levels: with minimum (zero) and maximum (unit) intensity of light that passed behind analyser. In FIG. 3 are shown the stress distribution diagrams (at the bottom) and nature of electrooptic response of liquid-crystal ferroelectric display cell (at the top) in bistable mode (thick line) and in multistable mode (thin lines). In the insertion on the right is the photo of structure of light and dark strips observed behind the analyser for some point of hysteretic modulation characteristic in multistable mode.

Taking into consideration the strict threshold and good multiplicity, memory property of on or off condition (they are equal in terms of physics) and high speed of switching on-off of electrooptic response during use of Clark-Lagerwall effect, bistable display cells showed good results at creation by Displaytech company of quick-response actively-matrix spatial light modulators, used, for example, for hologram recording in storage devices and for formation of binary filters in data processing schemes [6].

The absence of actual dithering (grey scale) in bistable SLC-cells, and along with it of the colour transfer essentially restricts the possibility of their implementation in optoelectronic devices and systems. To overcome this restriction in Displaytech company was proposed the solution on the basis of use of high-frequency electronics, namely to form grey scale by means of light modulation with different frequency [6, 7]. Wide-band addressing mode was provided due to fitting of SLM onto silicon control matrix. By virtue of such an approach by Displaytech company was created a whole spectrum of compact “digital” microdisplays [7] with huge number of elements (more than million) and small aperture (less than inch) competing with microdisplays on NLC basis and even surpassing them in image updating rate (up to 250 fps), allowing provision of sequential (alternating) change in colour instead of parallel (spatial).

Grey physical scale with stepped, close to continuous modulation characteristic in ferroelectric liquid-crystal display cell became possible to obtain [9] on the basis of light transmission conditions multistability effect in layers of non-helicoidal SLC (d<<p₀43 ∞), i.e. SLC with compensated helicoid that is obtained at use of components having the sign of optical activity opposite to the sign of base component with helicoidal spin-up of director, but the same sign of spontaneous polarization [2].

In layer of this SLC at value of spontaneous polarization more than 50 nC/cm² and defined value of applied electric field occurs spatially periodic modulation of polarization vector orientation with the period of several micrometers, resulting in observation behind analyser (FIG. 3) of light and dark strips parallel to planes of smectic layers. Light strips represent spatial domains, in which occurs complete reorientation (switching) of SLC director, and black strips represent the domains where director switching didn't start (or vice versa), provided that between these domains exist discernable boundaries (see photo on insertion of FIG. 3).

The reason of occurrence of strips structure with different light transmission is the spontaneous polarization, whereupon this structure is called the ferroelectric domains [10]. The effect of transmission states multistability is the result of simultaneous occurrence of two circumstances: SLC director bistable switching in every smectic layer and the presence of angle φ spatial modulation, occurring as the result of ferroelectric domains existence. The more is the value of spontaneous polarization, the more is strips frequency: for example, at Pₛ=60 nC/cm² their period is equal approximately to 30 μm, and at 130 nC/cm²—only about 3 μm. On changing of electric voltage value or duration of control pulse it is possible to control almost continuously the correlation between width of light and dark strips, i.e. integral grey tone over cell area. Herewith, like in the case of bistability, every transmission state in multistable mode is memorized, i.e. stored until reverse polarity pulse arrival. In multistable SLC layer with thickness of 1.6 μm the switching of any transmission state at stepped grey scale was carried out during time in the order of 70 and 90 microseconds at control voltage of ±15 and ±25 V respectively [9].

The closest analogue to alleged invention (the prototype) is the multistable ferroelectric liquid-crystal display cell [11]. This invention solves the problem of creation of cell with almost continuous modulation characteristic on the basis of physical grey scale implementation at use of multistability effect in SLC with high value of spontaneous polarization. Such cell contains two transparent plates with transparent current conducting coatings, spaced for more than 10 μm and connected to alternating sign electric voltage source. Within the space between the plates is placed the SLC that changes its optical anisotropy during voltage application, thereby the cell changes its transmission state and modulates the light passing through it. After voltage switching off the cell dependently on SLC molecular structure maintains conditions either of maximum or of minimum light transmission (bistability), or maintains any intermediate state of light transmission (multistability).

The effect of optical transmission states multistability is the consequence of stable bistability of electrooptic cells, in which exist spatially inhomogeneous structures of ferroelectric domains. That is why the multistability in general case can exist only in the presence of hysteresis. However, the presence of hysteresis is the obstacle for simple and one-valued settling of display cell transmission level.

As can be seen from the above, the multistable ferroelectric liquid-crystal display cell described in the RF Patent No. 2092883 [11] provides sufficiently high (up to 1 kHz) light amplitude-phase modulation frequency and nearly continuous modulation characteristic. However, it:
demands large amplitude of alternating sign pulses (tens of volts) for control, what doesn't allow the use of silicon integrated circuits for this purpose,
has high energy consumption because of the high applied voltage,
has resolution limitation due to large SLC layer thickness (more than 10 μm),
is unable to transmit a large number of half-tones due to its small-step (not purely continuous) modulation characteristic and the necessity of averaging of large number of black and white strips, what is impossible to provide at a small area of cell of present-day microdisplay with the size less than 10-20 micrometers,
has in general case the hysteretic modulation characteristic that essentially complicates one-valued addressing of display elements.

The problem solved in proposed ferroelectric liquid-crystal display cell is the obtaining in the cell of continuous anhysteretic modulation characteristic, permitting to perform light modulation with frequency of several kilohertz during cell addressing with alternating sign pulses with the amplitude less than ±3V (acceptable for control silicon integrated circuits) at small energy consumption by virtue of small value of applied voltage, with high (on account of cell size and number of grey scales) resolving power. Thereby the problem is reduced to creation of liquid-crystal ferroelectric display cell, free of drawbacks specified for multistable ferroelectric liquid-crystal display cell, manufactured according to the RF Patent No. 2092883.

### Essence of Invention

The solution of specified problem is provided by means of that in known ferroelectric liquid-crystal display cell (FIG. 2) containing two parallel dielectric plates at least one of which should be transparent, whose internal sides are coated with current conducting coatings, at least one of which is made transparent, transparent anisotropic coating defining initial orientation of liquid crystal molecules in the absence of external electric field, deposited at least on one of the current conducting coating, dielectric coating that is deposited over one or both anisotropic coatings and is used for cell protection from electric interlocking and breakdown, ferroelectric liquid crystal, filling the space between dielectric coatings, changing its optical anisotropy under action of electric field, and the source of alternating sign electric voltage, characterized in that helicoid pitch and SLC layer thickness and boundary conditions for it are selected due to condition

K_{φ}q₀²˜W_{Q}/d (9),

where q₀ is the deformation wave vector.

The fulfilling of correlation 9 provides in the absence of electric field the SLC layer deformation in the form of partial spin-up of helicoid and initiating of domains formation. Herewith, the SLC layer thickness is chosen within the range of 0.9÷1.4 μm to satisfy the condition of light achromatic transmission by cell within the range of light wavelengths, modulated either in light transmitting, or light reflecting cell. Moreover, the dielectric coating can border with SLC layers only at one side.

Thus, the essence of proposed method is in creation in ferroelectric liquid-crystal display cell of conditions that, in the absence of electric field, provide SLC layer deformation in the form of partial spin-up of helicoid and initiating of domains formation, at the expense of which boundary movement will be performed the SLC director reorientation in electric field.

The technical result of proposed invention is the creation of ferroelectric liquid-crystal cell, where helicoid pitch and SLC layer thickness, as well as boundary conditions for it, determined by means of coefficient of cohesion with boundary surface, provide continuous anhysteretic modulation characteristic at cell addressing with alternating sign pulses with amplitude less than ±3V, light modulation frequency of several kilohertz, less energy consumption and better resolving power as compared to the prototype [11].

In the first variant of technical solution is considered the liquid-crystal cell performing light modulation at its single one-direction passing through the cell (FIG. 2a). In the second variant the technical problems are solved in the same principal way, and the difference from the first variant (transmission-type cell) is only in making of one of current conducting coatings reflecting (FIG. 2b), what is distinguishing for the reflective type cells.

The advantages of the proposed ferroelectric liquid-crystal display cell are implemented at the expense of selection of helicoid pitch and SLC layer thickness and boundary conditions suitable for it.

The main benefits of alleged ferroelectric liquid-crystal display cell as compared to the prototype finally are: the decrease of control alternating sign electric voltage for cell addressing up to ±3V and less, anhysteretic modulation characteristic at the light modulation frequencies of several kilohertz, the reduction of energy consumption, increase of spatial resolving power simultaneously with increase of possible number of grey scales (half-tones). Herewith from the pertinent art it is not obvious that in ferroelectric liquid-crystal display cell all the benefits can be achieved at the expense of selection of helicoid pitch and SLC layer thickness and boundary conditions suitable for it.

To improve the characteristics of light modulation in ferroelectric liquid-crystal display cell can be used separately or collectively the changing of the liquid-crystal substance type and composition, changing of cell control mode, modification of cell construction etc. For example, in it can be used polymer liquid-crystal layers; dielectric plates (substrates) can be made in the form of thin and flexible films; one of dielectric plates (substrates) can even be excluded, and the reflecting current conducting coating in this case can be made on silicon plate, in which is formed control integrated circuit, etc.

As can be seen from the above, the use of alleged ferroelectric liquid-crystal display cell provides in it the continuous anhysteretic modulation characteristic at control with alternating sign pulses with voltage less than ±3V at light modulation frequencies of several kilohertz, less energy consumption as compared to the prototype and better resolving power, provided that these results, just like the distinctive features of the invention (helicoid pitch and SLC layer thickness and boundary conditions for it) are essential.

### INDUSTRIAL APPLICABILITY

Proposed ferroelectric liquid-crystal display cell and the optical modulator on its basis are low-voltage, fast-response, manufacturable and effective device of light modulation. This makes possible to implement them in many present-day and advanced displays, single-channel and spatial light modulators, as well as in other data devices and systems of storage, conversion, processing imaging and displaying of data. Moreover, the application of proposed invention will facilitate the achievement of maximum response speed for such devices and systems.

### Embodiment of Invention

For implementation of the proposed invention several operative embodiments of ferroelectric liquid-crystal display cell and optical modulators on its basis were produced, and their characteristics were measured.

To provide in the operative embodiments in the absence of electric field the partial spin-up of helicoid structure of SLC and domains formation, at the expense of which boundary movement is performed the SLC director reorientation and birefringence change in electric field, were used the SLCs of various compositions, including the following:

| | Molar |
|---|---|
| Chemical structures | concentration (%) |
| 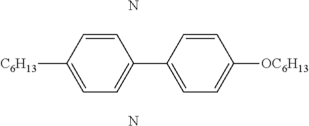 | 30.2 |
| 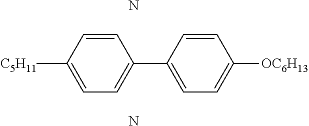 | 29.6 |
| 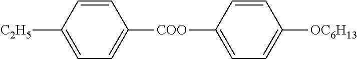 | 15.8 |
| 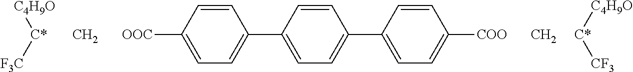 | 24.4 |

The temperature range of ferroelectric phase existence for this SLC was within the interval from +1° C. to +64° C., spontaneous polarization was equal to 48 nC/cm², rotational viscosity coefficient −0.75 poise, and helicoid pitch −0.45 μm. According to [12], SLC elastic energy can be obtained from the following correlation:

Wₑ₁=(K_{φ}q₀²)/2=Pₛ²/4χₛₜθ², (10)

where χₛₜ is the static value of dielectric susceptibility, θ is the slope angle of molecules in smectic layers. In the considered case χₛₜ=70, angle θ=23° (or 0.4025 rad) and the value of K_{φ}q₀² amounts about 900 erg/cm³.

As transparent anisotropic orientating coating was used the polyimide film made by means of centrifuge with thickness in the order of 30 nm that was polished. As dielectric coating was used aluminium dioxide film made by means of deposition with thickness of 80 nm.

For planar orientation of SLC director (FIG. 1a) quadratic coefficient of cohesive energy amounted W_{Q}=0.05 erg/cm². SLC layer thickness was 1.3 μm in display cells with light transmission and 1.0 μm in cells with light reflection, what gave for W_{Q}/d the value from 770 to 1000 erg/cm² and satisfied the correlation (9) with accuracy up to order of magnitude for specified energy types.

Molecules interaction with the surface caused helicoid partial spin-up. Helicoid pitch in electrooptic cell didn't change, but the azimuth angle φ in all the smectic layers became close to 0 or π. As the result, the SLC was divided into domains with the period in the order of p₀/2. For SLC with helicoid pitch p₀˜0.45 μm partial spin-up of helicoidal structure occurred at SLC layer thickness d=1.0÷1.3 μm.

The experiments demonstrated that in low fields (E<1 V/μm) at electric field change frequency more than 300 Hz the time of electrooptic response τ_{0.1-0.9} linearly depends on the field intensity. The increase of electric field intensity causes the sharp fall of time τ_{0.1-0.9}, and the increase of field frequency shifts the minimum of the dependence τ_{0.1-0.9}(E) to the area of higher field values.

During screening of transparent current conducting coating on one of the substrates of electrooptic cell with dielectric layer, the difference of polar coefficients of cohesive energy for both plates, influencing the speed of movement of the domain boundaries, was increased almost three times (from 0.015 to 0.04 erg/cm²), whereby the time of the cell electrooptic response decreased more than three times already at the field change frequency in the order of 200 Hz.

For the cell with light transmission and SLC layer thickness of 1.3 μm at electric field intensity of 1 V/μm the time of electrooptic response amounted 50÷70 μs. For the cell with light reflection (SLC layer thickness in the order of 1 μm), simulating the operation conditions in liquid-crystal microdisplays with control silicon matrix of F-LCOS type [6, 7], the time of electrooptic response amounted 45 μs at control voltage frequency of 200 Hz and field intensity of 1 V/μm, and at frequency of 2 kHz-35 μs.

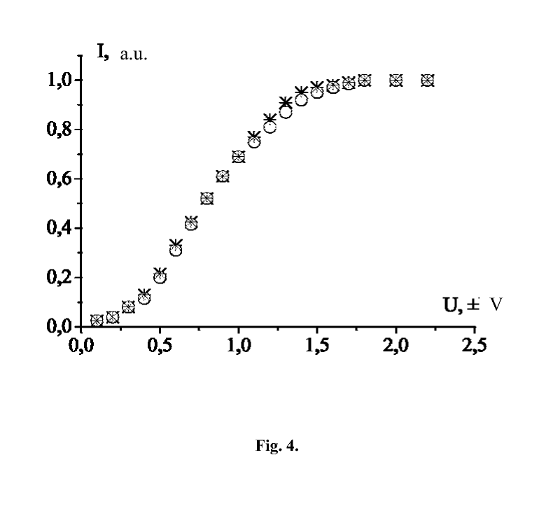

Experimentally observed in crossed polaroids light transmission I by the ferroelectric display cell with one-side dielectric coating in dependence on control voltage U (meander) at frequency of 1 kHz (b) at increase (*) and decrease (∘) of voltage value is shown in FIG. 4. It is seen that this dependence almost doesn't show hysteresis and is similar to one for the cells on the basis of nematic LC. However, experimentally measured values of electrooptic response persuade that the display cells on the SLC basis manufactured according to proposed invention allow obtaining of continuous modulation characteristic at the frequencies of several kilohertz with time of response of several tens of microseconds for control voltage less than ±3 V.

Thus the considered embodiment of invention confirms its efficiency, as well as essential advantages as compared to the prototype.

1. Ferroelectric liquid-crystal display cell containing two parallel dielectric plates, at least one of which should be transparent, whose internal sides are coated with current conducting coatings, at least one of which is made transparent, transparent anisotropic coating defining initial orientation of liquid crystal molecules in the absence of external electric field, deposited at least on one of the current conducting coating, dielectric coating that is deposited over one or both anisotropic coatings, ferroelectric liquid crystal, filling the space between dielectric coatings, changing its optical anisotropy under action of electric field, and the source of alternating sign electric voltage, characterized in that the thickness of SLC layer d, helicoid pitch p₀ and boundary conditions defined with coefficient W_{Q}, are chosen due to condition: K_{φ}q₀²˜W_{Q}/d, where K_{φ} is the elasticity modulus specifying SLC deformation over azimuth angle φ; q₀ is the deformation wave vector; W_{Q}—quadratic coefficient of energy of SLC cohesion to boundary surface.

2. Ferroelectric liquid-crystal display cell according to claim 1, characterized in that the thickness of liquid-crystal substance layer is chosen within the range of 0.9÷1.4 μm according to the condition of cell achromatic light transmission within the range of light wavelengths, modulated either in light transmitting, or in light reflecting cell.

3. Ferroelectric liquid-crystal display cell according to claim 1, characterized in that dielectric coating borders with SLC layer only at one side.
